(19) United States
(12) Patent Application Publication
(10) Pub. No.: US 2018/0046924 A1
(43) Pub. Date: Feb. 15, 2018

(54) WHOLE-LIFE-CYCLE POWER OUTPUT CLASSIFICATION PREDICTION SYSTEM FOR PHOTOVOLTAIC SYSTEMS

(71) Applicant: GUANGZHOU INSTITUTE OF ENERGY CONVERSION, CHINESE ACADEMY OF SCIENCES, Guangzhou (CN)

(72) Inventors: Lei HUANG, Guangzhou (CN); Jie SHU, Guangzhou (CN); Guixiu JIANG, Guangzhou (CN); Zhifeng WU, Guangzhou (CN); Qiong CUI, Guangzhou (CN); Hao WANG, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 15/549,668

(22) PCT Filed: Sep. 24, 2015
(86) PCT No.: PCT/CN2015/090587

§ 371 Date: Aug. 9, 2017

(30) Foreign Application Priority Data
Aug. 31, 2015 (CN) 201510552067.0

(51) Int. Cl. G06N 5/04; H02J 3/38; G01W 1/10; G06N 99/00

(52) U.S. Cl. CPC G06N 5/04; G06N 99/005; H02J 3/385; G01W 1/10

(57) ABSTRACT

A whole-life-cycle power output classification prediction system for photovoltaic systems. The power output classification prediction system comprises a basic information storage module, a database module, a prediction model judgment module, a prediction data pre-processing module and a prediction modeling module. The system selects different prediction models to carry out training and predication according to acquired data types and operation time of the photovoltaic system, is a modularized and multi-type photovoltaic system output power prediction system, can be suitable for output power prediction requirements of a majority of photovoltaic systems at present, can carry out customization according to the scale of the photovoltaic system, user requirements, etc., can both meet economic requirements and reliability requirements, and has good adaptability and transportability. The prediction method can update automatically. The prediction system can carry out automatic operation management. And relatively high prediction precision and stability are achieved.

### CROSS REFERENCE TO RELATED APPLICATIONS

This application is the national phase entry of International Application No. PCT/CN2015/090587, filed on Sep. 24, 2015, which is based upon and claims priority to Chinese Patent Application No.201510552067.0 (CN), filed on Aug. 31, 2015, the entire contents of which are incorporated herein by reference.

### TECHNICAL FIELD

The present invention relates to the field of photovoltaic technologies, and particularly to a whole-life-cycle classification prediction system for photovoltaic systems.

### BACKGROUND

Since the beginning of the 21st century, as the energy supply has become persistently tight worldwide, exploiting clean and efficient renewable energy is the main solution to energy problems in the future. At present, photovoltaic generation is the fastest-growing power generation technology based on renewable energy. It is predicted that, in the 21st century, photovoltaic generation will play an important role in world energy consumption that, it will not only replace some of the conventional energy resources, but also become a main energy resource all over the world. However, photovoltaic generation is different from traditional generation in that, the power output of a photovoltaic system is random, intermittent, and uncontrollable. Therefore, it is necessary to perform an accurate prediction on the photovoltaic generation which served as an important basis for planning, energy management and scheduling of photovoltaic system, so as to ensure stable and economic operation of photovoltaic system.

According to the type of input data, the existing photovoltaic power prediction models are categorized into three groups, including statistical models, physical models and combined models. In general, different prediction models require different inputs, while the most important factor affecting the power output of photovoltaic system is the local solar radiation. Thus, for a prediction model, solar radiation is an input of primary consideration in addition to the photovoltaic power. Other types of data that serves as the input of photovoltaic power prediction models include NWPs (Numerical Weather Predictions, such as solar radiation and temperature), historical and real-time meteorological data, photovoltaic system online data, and physical environmental data (such as photovoltaic cell information, photovoltaic array information, geographic location, etc.).

To improve the accuracy of photovoltaic power prediction, one should collect the types of data input mentioned above as many as possible. However, it is usually impossible to collect all types of data as it is limited by the scale and geographic location of the photovoltaic system. Generally, a conventional prediction system for photovoltaic power is designed towards a specific combination of data types, resulting in poor adaptabilities of the prediction systems. In addition, since a conventional prediction system usually requires input data of multiple types regardless of the difficulty in collecting the data, it is difficult to apply such a prediction system to photovoltaic systems located at remote areas or islands. Moreover, since the data type obtained from a photovoltaic system during its whole life cycle is not fixed, the power prediction method should be changed when the type of input data changes throughout the period from the planning stage to the operation stage, which is often ignored by the conventional prediction systems.

### SUMMARY OF THE INVENTION

An object of the present invention is to provide a photovoltaic power prediction system with various combinations of model input and various prediction steps, which is suitable for the whole life cycle of a photovoltaic system. The photovoltaic power prediction system has the advantages such as easy operation, flexible extensibility of the input data types, abundant prediction methods, and high applicability. Thus the system is applicable to various types of photovoltaic systems in providing basic information to planning and energy management systems of the photovoltaic systems. It can improve the accuracy of photovoltaic power prediction and reduce the development cost for redesigning the photovoltaic power prediction systems due to the changes of systems. In order to achieve the above object, the present invention adopts the following technical solutions.

Provided is a whole-life-cycle power output classification prediction system for photovoltaic systems, comprising:

a basic information storage module, configured to store basic information of the photovoltaic system including geographical location, historical meteorological information, installation information and inverter information;

a database module, configured to classify and store data required by a prediction modeling, including photovoltaic system operation data, environmental monitoring data, weather forecasting data and numerical weather predictions, and further configured to store the basic information in the basic information storage module;

a prediction model judgment module, configured to determine a prediction model, based on types of the data stored in the database module and how long the photovoltaic system has been put into operation;

a prediction data pre-processing module, configured to perform an averaging treatment on the data in the database module to obtain input-output model training samples and prediction input samples; and

a prediction modeling module, configured to perform model training and prediction on the samples from the prediction data pre-processing module, according to the prediction model determined by the prediction model judgment module, to obtain prediction results of the power output of the photovoltaic system.

Compared with the prior art, the present invention has the advantages as follows.

1. In view of the various types of the modeling data obtained from the photovoltaic system, the present invention adopts a corresponding prediction type for every common combination of data, and thus the prediction system has excellent adaptability in that it is suitable for photovoltaic systems of various types.

2. The present invention allows a flexible prediction during the whole life cycle of the photovoltaic system. Depending on how long the photovoltaic system has been put into operation, the prediction system employs various prediction models, such that it selects a suitable prediction algorithm and model for every stage according to the type of modeling data, and thereby the accuracy of the prediction is improved.

3. The present invention adopts a modular design, wherein the modules are distinct in function and have clear interfaces therebetween. The prediction system can be customized to meet users' requirements, wherein certain module functions can be enabled or disabled flexibly, such that not only can the prediction cost of a small-scale photovoltaic system be reduced, but also can the users' requirements of large-scale photovoltaic systems be met.

### BRIEF DESCRIPTION OF THE DRAWINGS

FIG. 1 shows a structural diagram of the power output classification prediction system of the present invention.

FIG. 2 is shows a prediction process of the power output classification prediction system of the present invention.

FIG. 3 shows a process of identifying and correcting bad data by the power output classification prediction system of the present invention.

FIG. 4 shows an equivalent circuit diagram of a photovoltaic module.

FIG. 5 shows the prediction types 1, 2 and 3 employed in the power output classification prediction system of the present invention.

FIG. 6 shows the prediction types 4 and 5 employed in the power output classification prediction system of the present invention.

FIG. 7 shows the prediction type 6 employed in the power output classification prediction system of the present invention.

### DETAILED DESCRIPTION

The present invention will be described in further detail with reference to specific embodiments hereinafter.

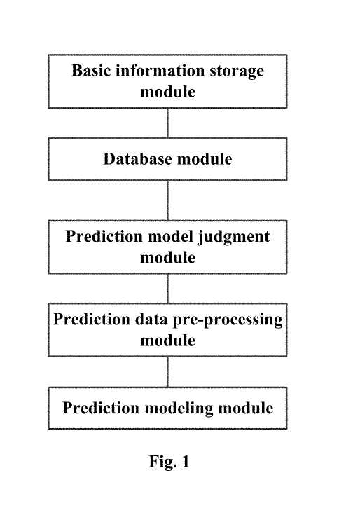

As shown in FIG. 1, a power output classification prediction system suitable for the whole life cycle of a photovoltaic system comprises:

a basic information storage module, configured to store basic information of the photovoltaic system including a geographical location, historical meteorological information, installation information and inverter information;

a database module, configured to classify and store data required by a prediction modeling, including photovoltaic system operation data, environmental monitoring data, weather forecasting data and numerical weather predictions;

a prediction model judgment module, configured to determine a prediction model, based on types of the data stored in the database module and how long the photovoltaic system has been put into operation;

a prediction data pre-processing module, configured to perform an averaging treatment on the data in the database module to obtain input-output model training samples and prediction input samples; and

a prediction modeling module, configured to perform model training and prediction on the samples from the prediction data pre-processing module, according to the prediction model determined by the prediction model judgment module, to obtain prediction results of the power output of the photovoltaic system.

The data stored in the database module are of various types, and can be data from every stage of the photovoltaic system. Accordingly, in the present invention, different prediction models are employed for training and prediction depending on the types of the data and how long the system has been put into operation, so as to improve the applicability, the flexibility and the predictive accuracy of the present prediction system.

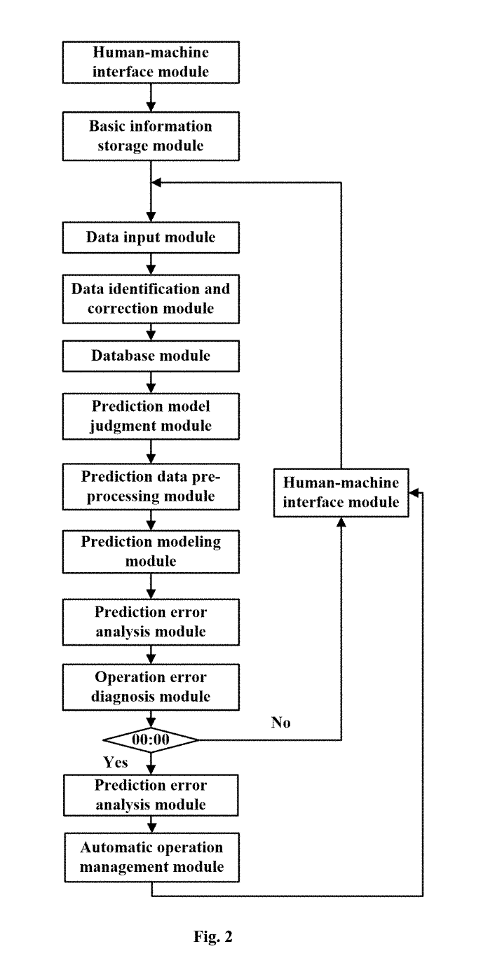

In a preferred embodiment, the prediction system comprises a basic information storage module, a data input module, a data identification and correction module, a database module, a prediction model judgment module, a prediction data pre-processing module, a prediction modeling module, a prediction error analysis module, a operation error diagnosis module, an automatic operation management module, and a human-machine interface module. As shown in FIG. 2, the basic information storage module is the initial executing module of the photovoltaic prediction system. After the basic information storage module is executed, the photovoltaic power prediction system enters a cyclic prediction procedure, wherein the order of execution of the cyclic process is as follows: the data input module, the data identification and correction module, the database module, the prediction model judgment module, the prediction data pre-processing module, the prediction modeling module, the prediction error analysis module, and the operation error diagnosis module; and then a time judgment is performed. If it is not at zero hour , then the prediction-relating result is returned to the human-machine interface and the prediction database, and the cycle is restarted; if it is at zero hour, then the prediction error analysis module is executed to perform statistics of the errors, the automatic operation management module is executed, then the related statistical result is returned to the human-machine interface and the prediction database, and the cycle is restarted.

The basic information storage module stores basic information of the photovoltaic system including the geographical location information, historical meteorological information, installation information and inverter information. The geographical location information includes the longitude, the latitude, the altitude, and the extent how much the system is obscured by shadow. The historical meteorological information includes the solar radiance information and the ambient temperature information which are obtained hourly/monthly/daily from websites of weather stations, the NASA, the NOAA, etc. The installation information includes the data plate information of photovoltaic modules, electric connection information of the photovoltaic modules, the number of arrays, the installation angles, the mounting manner, etc. The data plate information of photovoltaic module includes the short circuit current, the open circuit voltage, voltage at the maximum power point, current at the maximum power point, temperature coefficient of voltage, temperature coefficient of current, the module efficiency attenuation information, etc,. Regarding the module efficiency attenuation information, the default value of efficiency attenuation of PV modules is set to be 3% for the first year, and 0.7% for every subsequent year. The number of the arrays is determined based on the number of the inverters. The installation angles include the tilt angle and the azimuth angle. The mounting manner includes the rack-mounted type, the building component-integrated type, and the building material-integrated type. The inverter information includes the rated powers, the efficiencies and the maximum power tracking ranges.

The data input module comprises an inverter operating data input module, an environmental monitoring input module, an NWPs input module, and a weather forecasting input module. Inverter operation data includes the on/off state, the input voltage, the input current, the input power, the output voltage, the output current and the output power of each inverter. Environmental monitoring data includes global horizontal irradiance, diffuse solar irradiance, direct solar irradiance, ambient temperature, and module temperature. NWPs include the global horizontal irradiance and the ambient temperature. The weather forecasting data includes the weather condition, the wind strength, the ambient temperature, the humidity, etc, which are collected during the daytime.

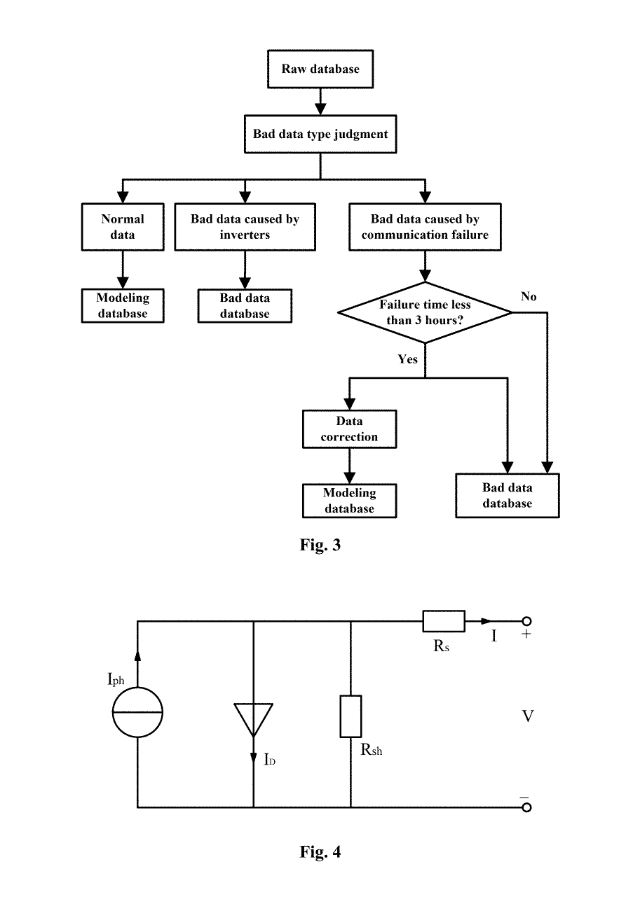

The data identification and correction module is configured to identify bad data and process historical data. The bad data refers to data that cannot be used for prediction modeling, and is mainly categorized into two types. One type of the bad data refers to uncorrectable data, including data of obvious power change caused by inverters, and data that is obtained during a long-time communication failure; and the other type of the bad data refers to that can be used for prediction modeling after it is corrected and complemented, including data that is obtained during a short-time communication failure. As shown in FIG. 3, the bad data caused by inverters refers to that caused by inverter failure, scheduling control of the power output of photovoltaic inverters, etc.; such bad data is uncorrectable and will be directly stored into the bad data database. The bad data caused by a communication failure mainly relates to the following three situations: 1), data duplication, namely, duplicate sample time and data; 2) data distortion, where the boundary conditions are not satisfied, or there are a series of data being identical with each other and not equal to 0; and 3) data missing. Regarding the three situations, the following solutions are provided accordingly: 1) directly deleting the duplicate data; 2) regarding the situation where the boundary conditions are not satisfied or there are a series of data being identical with each other obtained during an ultra-short term prediction, performing a correction with the moving average values of the first five values before the distorted data; if the series of identical data is obtained during a communication failure shorter than 3 hours, then searching the similar historical time period, and correcting the fault data with the data obtained from the similar historical time period, and storing the corrected data in a modeling database; for a failure lasting for more than 3 hours which is determined to be a long-time communication failure, then storing the data of that day into the bad data database; and 3) the solution is identical with that in 2).

The database module comprises a raw database, a modeling database, a bad data database and a prediction result database. After the completion of every hourly prediction, and at 00:00 every day, data obtained in the previous hour or day which is stored in the raw database is identified and corrected, and then stored into the bad database or the modeling database for subsequent prediction modeling. If there is neither bad data nor missing data among the data obtained in the previous hour or day, then data of the day will be directly stored into the modeling database in chronological order. If there is uncorrectable bad data, then instead of being stored into the modeling database, the data of the day will be marked, backed up, and stored into the bad data database for future reference. If there is correctable bad data, then the data of the day will be stored into the modeling database in chronological order after the bad data is corrected and complemented.

The prediction model judgment module decides which prediction model should be employed, based on the types of the sub-databases in the modeling database. Further, if it is prediction type 1, then prediction model 11 is employed to predict the photovoltaic power/output. If it is prediction type 2, then prediction model 21 is employed when the photovoltaic system has been put into operation for less than one month, prediction model 22 is employed when the photovoltaic system has been put into operation for more than one month but less than six months, and prediction model 23 is employed when the photovoltaic system has been put into operation for more than six months. If it is prediction type 3, prediction models 31 and 32 are respectively identical with the prediction models 21 and 22, and prediction model 33 is employed when the photovoltaic system has been put into operation for more than six months. If it is prediction type 4, then prediction model 41 is employed when the photovoltaic system has been put into operation for less than one month, prediction model 42 is employed when the photovoltaic system has been put into operation for more than one month but less than six months, and prediction model 43 is employed when the photovoltaic system has been put into operation for more than six months. If it is prediction type 5, prediction models 51 and 52 are respectively identical with the prediction models 41 and 42, and prediction model 53 is employed when the photovoltaic system has been put into operation for more than six months. If it is prediction type 6, then prediction model 61 is employed when the photovoltaic system has been put into operation for less than one month, prediction model 62 is employed when the photovoltaic system has been put into operation for more than one month but less than six months, and prediction model 63 is employed when the photovoltaic system has been put into operation for more than six months.

The prediction data pre-processing module is configured to perform an averaging treatment, and prepare a model training sample and a prediction sample. The averaging treatment refers to an averaging process implemented in the modeling database and real-time data according to the predetermined resolution of the prediction, the default of which is set to be 15-minunte, 30-minute or 1-hour. After the averaging treatment, an input sample and an output sample required for model training are prepared according to the selected model, and a prediction input sample is prepared as well.

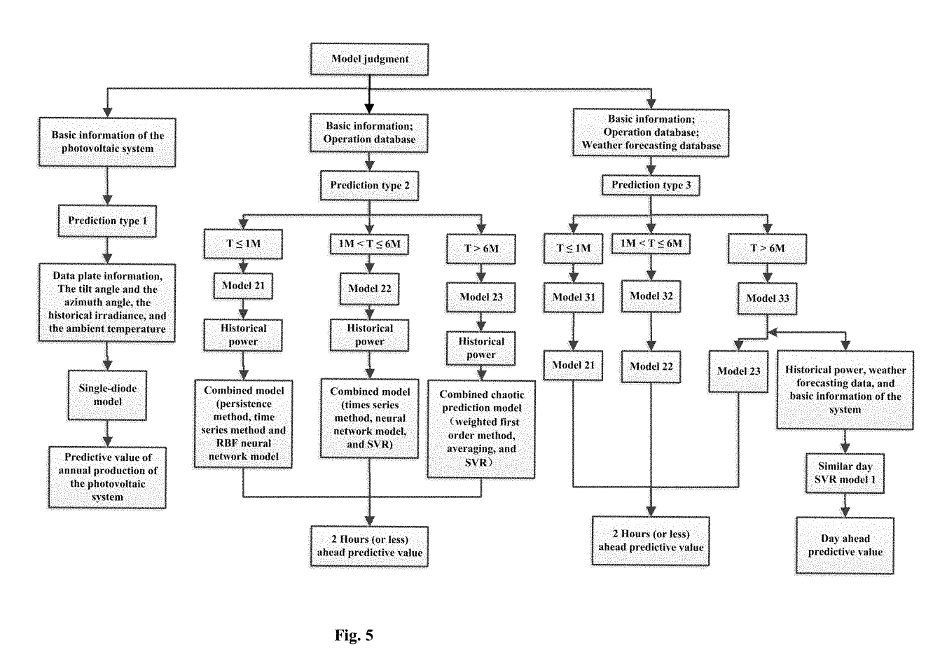

As shown in FIGS. 5, 6 and 7, the prediction modeling module includes six prediction types, wherein the prediction type 1 includes one prediction model which is denoted as the prediction model 11, and each of the other five prediction types includes three prediction models respectively.

Further, as shown in FIG. 4, the prediction model 11 adopts a single-diode model (having five parameters, a photocurrent Iph, a diode reverse saturation current Is, a diode ideality factor n, a series resistance Rs and a parallel resistance Rp) for photovoltaic cell to calculate the power output of the photovoltaic system according to the information of the photovoltaic module including the data plate information, the installation tilt angle, the azimuth angle of the arrays, and the historical hourly/daily/monthly irradiance and the corresponding average temperature. The solution comprises the following steps: (1) establishing a single-diode model for the photovoltaic module, and solving the model using five constraint equations including a short-circuit equation, an open-circuit equation, a circuit equation at the maximum power point, a equation of the derivative of the power curve at the maximum power point, and an equation of the thermal coefficient of voltage; (2) based on the installation tilt angle, the azimuth angle and the historical irradiance, calculating the effective irradiance to the photovoltaic module, and converting the ambient temperature into the module temperature; and (3) substituting the value of the effective irradiance and the module temperature into the model obtained in step (1) to obtain the power output of the photovoltaic system.

Further, as shown in FIG. 5, the prediction type 2 includes prediction models 21, 22 and 23. The prediction model 21 allows a two-hour (or less) ahead prediction, for the prediction of a photovoltaic system whose database has collected data for less than one month. When the database has collected data for less than ten days, then a persistence method is employed for prediction. When the database has collected data for more than ten days but less than one month, a combined model is established combining a persistence method, a time series method and a neural network model, with the following steps: (1) establishing a persistence method-based prediction model and an ARIMA prediction model respectively using historical power data of the previous 10 days; (2) taking output of the two models above as input of the neural network and taking the actual power as output of the neural network to train the RBF neural network, so as to obtain the combined prediction model; and (3) substituting the input values into the persistence method-based model and the ARIMA model, and performing a prediction using the combined model to obtain a 2-hour (or less) ahead predictive value of the photovoltaic system at a specific resolution. The prediction model 22 allows a two-hour (or less) ahead prediction, for the prediction of a photovoltaic system whose database has collected data for more than one month but less than six months. A combined model is established combining a time series method, a neural network model and a support vector regression model, with the following steps: (1) establishing an ARIMA prediction model using historical power data of the previous 15 days; (2) training the RBF neural network using historical power data of the previous 30 days, so as to establishing a prediction model; (3) taking output of the ARIMA prediction model and the RBF neural network model as input of the support vector regression (SVR) model and taking the actual power as output of the SVR model to train the SVR model, so as to obtain a combined prediction model; and (4) substituting the input values into the ARIMA prediction model and the RBF neural network model, and performing a prediction using the combined model to obtain a 2-hour (or less) ahead predictive value of the photovoltaic system at a specific resolution. The prediction model 23 allows a two-hour (or less) ahead prediction, for the prediction of a photovoltaic system whose database has collected data for more than six months. The prediction model is established using a chaotic prediction method, combining an weighted first-order prediction method and a SVR model, which can effectively extract data from those similar to the prediction point so as to improve the predictive accuracy, with the following steps: (1) constructing a series of average photovoltaic power at a predetermined predictive resolution (where a M-minute ahead prediction is performed), and constructing (M−1) auxiliary photovoltaic power series to form a multi-dimensional time series; (2) making a phase space reconstruction of the multi-dimensional time series, extracting a time delay τ of each time series using the C-C method, and selecting an embedding dimension d of each time series by the minimum error calculation method, wherein the embedding dimension of each auxiliary photovoltaic power series is set to be 1; (3) in the reconstructed phase space, calculating the Euclidean distances from the prediction point to other historical phase points, selecting K phase points having the nearest distances as neighbors; (4) averaging the values of the K neighbors at the next time point to obtain a predictive value 1; (5) taking the K neighbors as input of the SVR and taking the values of the neighbors at the next time point as output of the SVR, performing a grid optimization on the SVR parameters with K groups of training samples, training the SVR model with C and γ obtained in the optimization and with the K groups of training samples, and inputting the prediction point into the SVR model to obtain a predictive value 2; (6) performing a first-order local linear regression on the neighbors and the values at the next time point to obtain a weighted first-order local predictive value, namely a predictive value 3; and (7) averaging the three predictive values to obtain a final predictive value of the model.

Further, as shown in FIG. 5, the prediction type 3 includes prediction models 31, 32 and 33. The models 31 and 32 are identical with the models 21 and 22 respectively. The prediction model 33 allows a two-hour (or less) ahead prediction and a day-ahead prediction, for the prediction of a photovoltaic system whose database has collected data for more than six months. When it is for a two-hour ahead prediction, the prediction model 33 is identical with the model 23. When it is for a day-ahead prediction, the model 33 performs the prediction by combining the historical photovoltaic power, weather forecasting information, and the clear sky solar irradiances. And a prediction model is established by using weather forecasting data to search for similar days, with the following steps. (1) Calculating the clear day solar irradiance using the HOTTEL model with the latitude, the longitude, the time point and the altitude. (2) Selecting similar days according to the clear sky solar radiance, the maximum temperature, the minimum temperature, the weather situation, and the historical power data of the previous day of the prediction day, wherein the selecting similar days particularly comprises the following steps: a, based on the forecasted weather situation, selecting historical days which are similar to the prediction day in weather type, which is categorized into sunny, cloudy, overcast, light rain, moderate rain, heavy rain, thundershower, fog and so on; b, according to the calculated clear sky solar irradiance of the prediction day, selecting K₁ days having the nearest Euclidean distances to the prediction day in clear sky solar irradiance (6:00-19:00), from the historical days having similar weather type, and the value of K₁ is determined through a simulation trial; c, further selecting similar days from the K₁ similar days selected in step b based on temperature similarity; Tₙ represents the temperature of the prediction day, Tₙ=[Tₙ(1), Tₙ(2)], and Tₙ(1) and Tₙ(2) respectively represent the maximum temperature and the minimum temperature of the prediction day; the vector of one of the K₁ days is as Tᵢ=[Tᵢ(1), Tᵢ(2)], and i=1, 2, . . , K₁; and similar days having Euclidean distances from Tᵢ to Tₙ shorter than 3 are selected; and d, for the similar days which meet the Euclidean distance requirement, calculating the similarity between the power of the previous day of each similar day and the power of the previous day of the prediction day, selecting K₂ days having the highest similarities as the final similar days to establish a day-ahead photovoltaic power prediction model. (3) Averaging the power value of the corresponding time point of the similar days to obtain a predictive result 1. (4) Establishing day-ahead photovoltaic generation SVR prediction models to obtain a predictive result 2 by dividing the similar days into hours, (that is, there are totally fourteen models from 6:00 to 19:00), with the following steps: a, normalizing the solar irradiances, the temperatures and the humidities of the similar days and the prediction day to [0, 1]; b, taking the normalized solar irradiances, temperatures (including the maximum and minimum temperatures) and humidities (including the highest humidity and the lowest humidity) at the same time period of the similar days as inputs of the SVR, and taking the hourly average photovoltaic power as output of the SVR, and training the SVR model by taking the similar days as training samples to obtain 14 models corresponding to the 14 time points; and c, substituting the normalized solar irradiances, temperatures and humidities of the prediction day into the 14 SVR models to obtain predictive values of the photovoltaic power of the prediction day from 6:00 to 19:00, which can be adjusted according to the longitude.

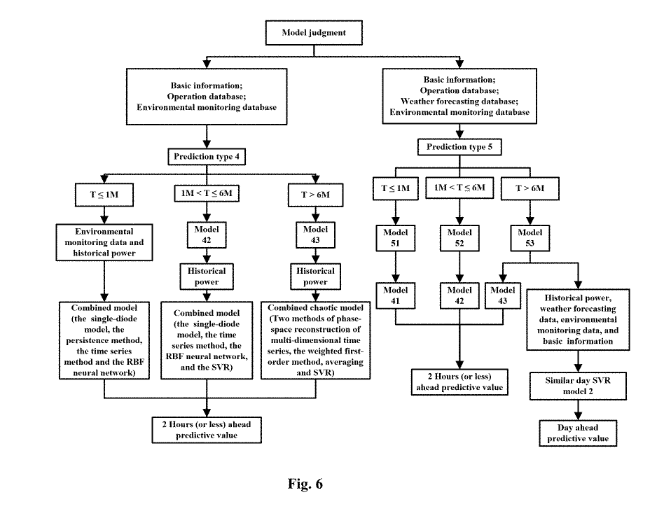

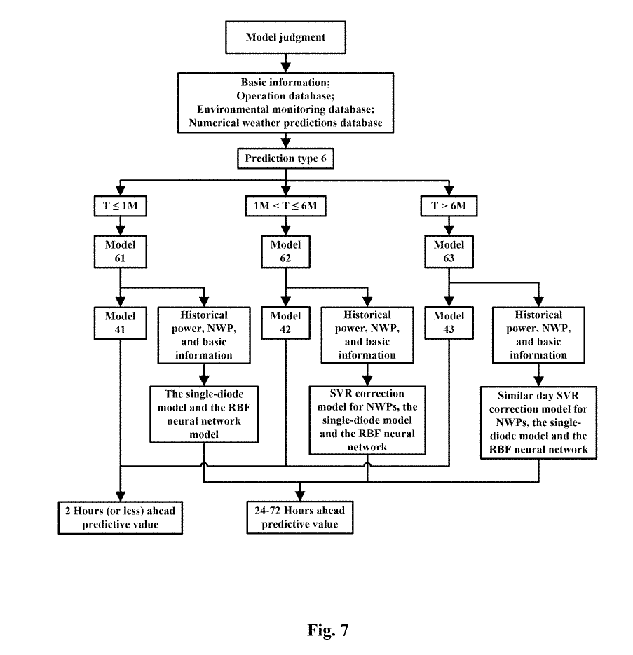

Further, as shown in FIG. 6, the prediction type 4 includes the prediction models 41, 42 and 43. The prediction model 41 allows a two-hour (or less) ahead prediction, for the prediction of a photovoltaic system whose database has collected data for less than one month. When the database has collected data for less than 10 days, then a persistence method is employed to predict the solar irradiance, the ambient temperature and the photovoltaic power respectively, so as to obtain a solar irradiance predictive value, an ambient temperature predictive value, and a photovoltaic power predictive value 1. The ambient temperature is converted into the module temperature, and the solar irradiance is converted into the effective solar irradiance to the tilted surface of the photovoltaic module. Then, the effective solar irradiance predictive value and the module temperature predictive value are substituted into a photovoltaic module model established from the model 11 to obtain a photovoltaic power predictive value 2. The two predictive values are averaged to obtain a final photovoltaic power predictive value. When the database has collected data for more than 10 days but less than one month, then a combined model is established combining a persistence method, a time series method and a neural network method to predict the solar irradiance, the ambient temperature and the photovoltaic power respectively (having steps similar to those of the model 21), so as to obtain a solar irradiance predictive value, a ambient temperature predictive value, and a photovoltaic power predictive value 1. The ambient temperature is converted into the module temperature. Then, the solar irradiance predictive value and the ambient temperature predictive value are substituted into a photovoltaic module model established from the model 11 to obtain a photovoltaic power predictive value 2. Taking the photovoltaic power predictive values 1 and 2 as inputs of the RBF neural network, and taking the actual photovoltaic power as output of the neural network, so as to train the model; and substituting the predictive sample into the prediction model to obtain a photovoltaic power predictive value. The prediction model 42 allows a two-hour (or less) ahead prediction, for the prediction of a photovoltaic system whose database has collected data for more than one month but less than six months. A combined model is established combining a time series method, a neural network model and a support vector regression model, to predict the solar irradiance, the ambient temperature and the photovoltaic power respectively (having steps similar to those of the model 22), so as to obtain a solar irradiance predictive value, a ambient temperature predictive value, and a photovoltaic power predictive value 1. The ambient temperature is converted into the module temperature. Then, the solar irradiance predictive value and the ambient temperature predictive value are substituted into a photovoltaic module model established from the model 11 to obtain a photovoltaic power predictive value 2. Taking the photovoltaic power predictive values 1 and 2 as inputs of the SVR model, and taking the actual photovoltaic power as output of the SVR model, so as to train the model; and substituting the predictive sample into the prediction model to obtain a photovoltaic power predictive value. The prediction model 43 allows a two-hour (or less) ahead prediction, for the prediction of a photovoltaic system whose database has collected data for more than six months. Through employing a chaotic prediction method, the prediction model is established by searching for neighbors who are similar to the prediction point using two reconstructed phase spaces of multi-dimensional time series, with the following steps: (1) constructing the multi-dimensional time series by utilizing a method identical to that of the model 23, and establishing a prediction model to obtain a photovoltaic power predictive value 1; (2) constructing a three-dimensional time series using the historical photovoltaic power, the solar radiance and the ambient temperature, reconstructing the phase space by the C-C method and the minimum error calculation method, searching the reconstructed phase spaces for the neighbors similar to the prediction point, and establishing an SVR prediction model for the neighbors by using steps (4)-(7) in the method of the model 23 to obtain a photovoltaic power predictive value 2; (3) taking the photovoltaic power predictive values 1 and 2 as inputs of the SVR model, and the actual photovoltaic power as output of the SVR model to perform optimization and training on the SVR model parameters; and (4) substituting the predictive input sample into the model to obtain output of the SVR model as the final photovoltaic power predictive value.

Further, as shown in FIG. 6, the prediction type 5 includes the prediction models 51, 52 and 53. The models 51 and 52 are respectively identical to the models 41 and 42. For the prediction of a photovoltaic system whose database has collected data for more than six months, the prediction model 53 is employed to achieve a two-hour (or less) ahead prediction and a day-ahead prediction, and is established with the following steps. (1) This step is identical to step (1) of the model 33. (2) Items a to c are identical to those of step (2) of the model 33; d. for the similar days which meet the Euclidean distance requirement, calculating the similarity in the power, the irradiance and the temperature between the previous day of each similar day and the previous day of the prediction day, selecting K₂ days having the highest similarities as the final similar days to establish a day-ahead photovoltaic power prediction model. (3) This step is identical to step (3) of the model 33. (4) This step is identical to step (4) of the model 33.

Further, as shown in FIG. 7, the prediction type 6 includes the prediction models 61, 62 and 63. The prediction model 61 allows a two-hour (or less) ahead prediction and a 24 to 72-hour ahead prediction, for the prediction of a photovoltaic system whose database has collected data for less than one month. The method for the two-hour (or less) ahead prediction is identical to that of the prediction model 41. The model for the 24 to 72-hour ahead prediction, which is dependent on the accuracy of NWPs, is established with the following steps: (1) respectively converting the solar irradiance and the ambient temperature in the NWPs, to an effective solar irradiance to the tilted surface of the photovoltaic module and a module temperature; (2) substituting the effective solar irradiance and the module temperature into the photovoltaic module model to obtain a 24 to 72-hour ahead power prediction series 1; (3) taking the solar irradiance and the ambient temperature in the environmental monitoring database as inputs of the RBF neural network, and taking photovoltaic power at the corresponding time points as output thereof, so as to train the RBF neural network; (4) substituting the solar irradiance and the ambient temperature, which are form the NWPs, into the RBF neural network prediction model to obtain a 24 to 72-hour ahead power prediction series 2; and (5) averaging the power prediction series 1 and the power prediction series 2 to obtain the final 24 to 72-hour ahead power predictive values. The prediction model 62 allows a two-hour (or less) ahead prediction and a 24 to 72-hour ahead prediction, for the prediction of a photovoltaic system whose database has collected data for more than one month but less than six months. The method for the two-hour (or less) ahead prediction is identical to that of the prediction model 42. The model for the 24 to 72-hour ahead prediction is established with the following steps. (1) Correcting the NWPs, specifically by establishing fourteen NWPs correction models of divided time periods, wherein the establishing comprises: taking the solar irradiance and the ambient temperature of the NWPs at the same time period of the previous 30 days of the prediction day as inputs of the SVR model, taking the solar irradiance and the ambient temperature in the environmental monitoring database as outputs of the SVR model, and performing parameter optimization and training on the SVR model using a genetic algorithm or an ant colony algorithm to obtain the NWPs correction models. (2) Employing the model 61 to perform the 24 to 72-hour ahead prediction with the corrected NWPs. The prediction model 63 allows a two-hour (or less) ahead prediction and a 24 to 72-hour ahead prediction, for the prediction of a photovoltaic system whose database has collected data for more six months. The method for the two-hour (or less) ahead prediction is identical to that of the prediction model 43. The model for the 24 to 72-hour ahead prediction is established with the following steps. (1) Correcting the NWPs, wherein the correction method is as follows: a, based on the solar irradiance, the ambient temperature and the wind speed among the historical NWPs, sequentially selecting K₃ days who have the nearest Euclidean distances of the solar irradiance, the ambient temperature and the wind speed to the prediction day (6:00-19:00), wherein the value of K₃ is determined through a trial and error method; b, establishing fourteen NWPs correction models of divided time periods, wherein the establishing comprises: taking the solar irradiance and the ambient temperature of the NWPs at the same time period as inputs of the SVR model, taking the solar irradiance and the ambient temperature in the environmental monitoring database as outputs of the SVR model, and performing parameter optimization and training on the SVR model using a genetic algorithm or an ant colony algorithm to obtain the NWPs correction models. (2) Employing the model 61 to perform the 24 to 72-hour ahead prediction with the corrected NWPs.

The prediction error analysis module is configured to perform calculation and statistics on the errors of the prediction models, and to judge whether the non-chaotic prediction models need to be updated based on the statistical result. Further, the module provides the confidence intervals of the predictive values under different weather situations, based on the statistical result of the errors in relative to the weather types. Moreover, each day is divided into three time periods, i.e., the 6:00-10:00 period, the 11:00-14:00 period and the 15:00-19:00 period; the module provides the confidence intervals of the predictive values at each period, based on the statistical result of the errors in relative to the each period. And furthermore, the module is configured to compare the NWPs and the environmental monitoring data, and perform calculation and statistics on the errors at each period.

The operation error diagnosis module comprises an operation error monitoring module, an operation error logging module and an error alarm module. The operation error monitoring module is configured to put the error information detected during the operation of the system into the operation error logging module. The error information mainly comprises: 1) Failing to obtain the photovoltaic system operation data, which makes it impossible to obtain the latest historical power data from the database. (2) The historical power data in the operation database is incomplete or includes seriously bad data. 3) Generation prediction fails. 4) A communication network for the connection to a weather station is off 5) There is no required weather forecasting result in the weather information server. 6) The historical meteorological data in the environmental monitoring database is incomplete. The operation error logging module is configured to divide the retrieved error information into two categories, i.e., the fatal errors (error type 1-3) and the non-fatal errors (the errors relating to the above types 4-6), and write the detailed information of the errors into an intraday operation error log by category. The error alarm module is configured to automatically check the intraday operation error log after the hourly prediction is completed. If there is a fatal error, a flashing red alarm window pops up to indicate that the situation is serious and the system requires manual intervention; if there is a non-fatal error, a yellow alarm window pops up to warn the operation personnel; and if there is no error, then no window pops up, indicating that the it is normal at the moment and manual intervention is not required.

The automatic operation management module comprises a daily operation logging sub-module and a monthly operation logging sub-module. The daily operation logging sub-module runs automatically at 00:00 every day to perform statistical analysis on the operation situation of the previous day, wherein the statistical analysis comprises: (1) basic information of prediction: day types, weather forecasting information, NWPs information, and the adopted prediction type and prediction model; (2) system operation situation: at that day, whether the system operation is normal, whether the acquisition of operation data of the photovoltaic system is successful, whether the meteorological data is retrieved successfully, whether the historical power data is complete, whether the historical meteorological data is complete, and whether the historical environmental monitoring data is complete; and (3) statistics of the operation result: the statistical result of power prediction errors, the statistic of NWPs errors, the situation of data corrections, etc. The monthly operation logging sub-module runs automatically at the first day of every month, and is configured to perform statistical analysis on the operation situation of the previous month, wherein the statistical analysis comprises: (1) basic information: which month it is, the weather conditions in the month, whether a special meteorological condition arises in this month, etc.; (2) system operation situation: the operating ratio of the system, generation rate of the operation error diagnosis report, the NWPs acquisition rate, the weather forecasting data acquisition rate, the data acceptability of the raw database, the modeling database correction rate, etc.; and (3) statistics of the operation result: the statistical result of power prediction errors, the statistic of NWPs errors, estimation of the upper and lower limits of the prediction accuracy of the month, etc.

The human-machine interface module is configured to view online and historical data/operating condition/alarm queries, and to provide convenient prediction system parameter setting and data importing functions to the users. Further, the human-machine interface module shows predictive results in the forms of real time data, real-time curves, historical tables and historical curves simultaneously, which facilitates query and correction. The module also shows other related data, such as the data of the previous time point, the ambient temperature, the solar irradiation, and so on. Further, an operation log query function and an error alarm function are provided. A related information tip is provided on the error alarm interface, wherein the power and meteorological data related to the error is shown in the form of curves or tables, to help the operation personnel to quickly determine and locate the error.

The present invention relates to a power output classification prediction system, which is suitable for the whole life cycle of a photovoltaic system, and is particularly suitable for photovoltaic systems of multiple types. The present invention provides a modular prediction system for predicting the power output of photovoltaic system, which can be customized according to the scale and the geographical location of the photovoltaic system, and the user's requirements, so that economic requirements and reliability requirements are met, and thereby the defects of conventional photovoltaic power prediction systems, such as poor flexibility and low stability, are overcome. The present invention takes the common data types of photovoltaic power prediction into consideration, including the basic information of the photovoltaic system, the photovoltaic power, the weather forecasting data, the environmental monitoring data and the NWPs, and classifies the photovoltaic power prediction types according to these data types, and employs different prediction methods according to the data obtained during the whole life cycle of the photovoltaic system, so that the requirements on power output prediction of most the current photovoltaic systems are met. Therefore, the system is excellent in adaptability and portability. In view of that a prediction system using only one model may have poor accuracy in some cases, the present invention adopts combined models as much as possible for different prediction types and at different time periods of the whole cycle life of the photovoltaic system. The adopted algorithms include the time series method, the RBF neural network method, the support vector regression (SVR) method, the phase space reconstruction-based chaotic prediction method, etc. Meanwhile, the prediction models adopted by the present invention are not fixed, that is, whether to update the prediction model is judged based on an error statistics result, or, when using the chaotic prediction method, an updated prediction model is used every time. Thus, the prediction system has higher predictive accuracy and can achieve stable automatic operation.

The above detailed description is a specific explanation for feasible embodiments of the present invention. The embodiments are not used for limiting the scope of the present invention. Any equivalent or changes made on the basis of the present invention shall fall within the scope of the present invention.

1. A computer-readable medium including contents that are configured to cause a computing system to classifiedly predict whole-life-cycle power output for photovoltaic systems, comprising:
a basic information storage module, configured to store basic information of the photovoltaic system including geographical location information, historical meteorological information, installation information and inverter information;
a database module, configured to classify and store data required by prediction modeling, including photovoltaic system operation data, environmental monitoring data, weather forecasting data and numerical weather predictions, and further configured to store the basic information in the basic information storage module;
a prediction model judgment module, configured to determine a prediction model, based on types of the data stored in the database module and how long the photovoltaic system has been put into operation;
a prediction data pre-processing module, configured to perform an averaging treatment on the data in the database module to obtain input-output model training samples and prediction input samples; and
a prediction modeling module, configured to perform model training and prediction on the samples from the prediction data pre-processing module, according to the prediction model determined by the prediction model judgment module, to obtain prediction results of the power output of the photovoltaic system.

2. The computer-readable medium of claim 1 further comprising:
a data input module, configured to acquire the data required by prediction modeling and import the acquired date into a raw database of the database module, and comprising four sub-modules: a photovoltaic system operation data input module, an environmental monitoring data input module, a numerical weather predictions input module and a weather forecasting data input module;
the database module, further comprising the raw database, a modeling database, a bad data database and a prediction result database;
a data identification and correction module, configured to identify, correct and record bad data in raw data imported by the data input module, store normal data and corrected bad data into the modeling database, and store uncorrectable bad data into the bad data database;
a prediction error analysis module, configured to perform calculation and statistics on errors of a prediction model, and to judge whether the prediction model needs to be updated based on a statistical result;
an operation error diagnosis module, configured to record error information detected during operation of the system to form an operation error log and give an alarm;
an automatic operation management module, configured to create daily operation logs and monthly operation logs for enquiry and record; and
a human-machine interface module, configured to provide online and historical data/operating condition/alarm queries to a user, and to provide parameter setting and data importing functions.

3. The computer-readable medium of claim 1 wherein in the basic information storage module,
the geographic location information includes a longitude, a latitude, an altitude, and how much the system is obscured by shadow;
the historical meteorological information includes solar radiance and ambient temperature information obtained hourly/monthly/daily from web sites of weather stations, the NASA and the NOAA;
the installation information includes data plate information of photovoltaic modules, electric connection information of the photovoltaic modules, number of arrays, installation angles and mounting manners; and
the inverter information includes rated powers, efficiencies and maximum power tracking ranges.

4. The computer-readable medium of claim 2, wherein
the data identification and correction module is further configured to judge the raw data:
if the raw data is judged to be bad data caused by an inverter, the data is stored in the bad data database; and
if the raw data is judged to be bad data caused by communication failure, then failure time is further judged; if the failure time is less than 3 hours, the data is corrected with a corresponding method and then stored in the modeling database;
otherwise, the data is stored in the bad data database.

5. The computer-readable medium of claim 1, wherein
the raw database, the modeling database and the bad data database of the database module respectively include an environmental monitoring database, a numerical weather predictions database, a weather forecasting database and a photovoltaic system operation database.

6. The computer-readable medium of claim 5, wherein
the prediction model judgment module is configured to judge a prediction type based on the type of sub-databases in the modeling database, and then to determine which prediction model should be employed, based on the prediction type and how long the photovoltaic system has been put into operation;
if there is not any data in the modeling database, then it is prediction type 1; if the modeling database includes the photovoltaic system operation database, then it is prediction type 2; if the modeling database includes the photovoltaic system operation database and the weather forecasting database, then it is prediction type 3; if the modeling database includes the photovoltaic system operation database and the environmental monitoring database, then it is prediction type 4; if the modeling database includes the photovoltaic system operation database, the environmental monitoring database and the weather forecasting database, then it is prediction type 5;
if the modeling database includes the photovoltaic system operation database, the environmental monitoring database and the numerical weather predictions database, then it is prediction type 6;
if it is the prediction type 1, prediction model 11 is adopted to predict the power output;
if it is the prediction type 2, prediction model 21 is adopted when the photovoltaic system has been put into operation for less than one month, prediction model 22 is adopted when the photovoltaic system has been put into operation for more than one month but less than six months, and prediction model 23 is adopted when the photovoltaic system has been put into operation for more than six months;
if it is the prediction type 3, prediction models 31 and 32 are identical with the prediction models 21 and 22 respectively, and prediction model 33 is adopted when the photovoltaic system has been put into operation for more than six months;
if it is the prediction type 4, prediction model 41 is adopted when the photovoltaic system has been put into operation for less than one month, prediction model 42 is adopted when the photovoltaic system has been put into operation for more than one month but less than six months, and prediction model 43 is adopted when the photovoltaic system has been put into operation for more than six months;
if it is the prediction type 5, prediction models 51 and 52 are identical with the prediction models 41 and 42 respectively, and prediction model 53 is adopted when the photovoltaic system has been put into operation for more than six months; and
if it is the prediction type 6, prediction model 61 is adopted when the photovoltaic system has been put into operation for less than one month, prediction model 62 is adopted when the photovoltaic system has been put into operation for more than one month but less than six months, and prediction model 63 is adopted when the photovoltaic system has been put into operation for more than six months.

7. The computer-readable medium of claim 6, wherein the prediction modeling module comprises:
the prediction model 11, adopting a photovoltaic module single-diode model to calculate, so as to obtain a predictive value of annual production of the photovoltaic system;
the prediction model 21, adopting a combined prediction model combining a persistence method, a time series method and an RBF neural network to achieve a 2-hour or less ahead photovoltaic power prediction;
the prediction model 22, adopting a combined prediction model combining the time series method, the RBF neural network and an SVR method to achieve a 2-hour or less ahead photovoltaic power prediction;
the prediction model 23, adopting a combined prediction model combining a multi-dimensional time phase space reconstruction, a weighted first-order method, and the SVR method to achieve a 2-hour or less ahead photovoltaic power prediction;
the prediction model 31, identical with the prediction model 21;
the prediction model 32, identical with the prediction model 22;
the prediction model 33, identical with the prediction model 23 for a two-hour ahead photovoltaic power prediction, or adopting a similar day SVR model 1 to achieve a day-ahead photovoltaic power prediction;
the prediction model 41, adopting a combined prediction model combining the photovoltaic module single-diode model, the persistence method, the time series method and the RBF neural network to achieve a 2-hour or less ahead photovoltaic power prediction;
the prediction model 42, adopting a combined prediction model combining the photovoltaic module single-diode model, the time series method, the RBF neural network and the SVR method to achieve a 2-hour or less ahead photovoltaic power prediction;
the prediction model 43, adopting a combined prediction model combining two methods of phase-space reconstruction of multi-dimensional time series, the weighted first-order method and the SVR method to achieve a 2-hour or less ahead photovoltaic power prediction;
the prediction model 51, identical with the prediction model 41;
the prediction model 52, identical with the prediction model 42;
the prediction model 53, identical with the prediction model 43 for a two-hour ahead photovoltaic power prediction, or adopting a similar day SVR model 2 to achieve a day-ahead photovoltaic power prediction;
the prediction model 61, identical with the prediction model 41 for a two-hour ahead photovoltaic power prediction, or adopting the single-diode model and the RBF neural network model to achieve a day-ahead photovoltaic power prediction;
the prediction model 62, identical with the prediction model 42 for a two-hour ahead photovoltaic power prediction, or adopting an SVR correction model for NWPs, the single-diode model and the RBF neural network to achieve a day-ahead photovoltaic power prediction; and
the prediction model 63, identical with the prediction model 43 for a two-hour ahead photovoltaic power prediction, or adopting a similar day SVR correction model for NWPs, the single-diode model and the RBF neural network to achieve a day-ahead photovoltaic power prediction.

8. The computer-readable medium of claim 2, wherein the operation error diagnosis module comprises:
an operation error monitoring module, configured to detect errors during the operation of the prediction system and input error information into an operation error logging module;
the operation error logging module, configured to store the operation error information of the prediction system; and
an error alarm module, configured to automatically check intraday operation error log after an hourly prediction is finished and give a corresponding alarm.

9. The computer-readable medium of claim 2, wherein the automatic operation management module comprises:
a daily operation logging sub-module, configured to run automatically at 00:00 every day and perform statistical analysis on operation situation of the previous day, including statistics of basic information of prediction, system operation situations and operation results; and
a monthly operation logging sub-module, configured to run automatically at the first day of every month and perform statistical analysis on operation situation of the previous month, including statistics of basic information, system operation situations and operation results.

10. The computer-readable medium of claim 9, further comprising a cyclic prediction control module, configured to control the system to enter a cyclic prediction operation after storing of the basic information storage module is finished, wherein
an execution order of one single process of the cyclic prediction operation is as follows: the data input module, the data identification and correction module, the database module, the prediction model judgment module, the prediction data pre-processing module, the prediction modeling module, the prediction error analysis module, and the operation error diagnosis module;
after the execution of the single process of the cyclic prediction operation, a time judgment is performed; if it is not at 00:00, the prediction result is returned to the human-machine interface module and the database module, and the cyclic prediction operation is restarted; or if it is at 00:00, the prediction error analysis module is executed to perform statistics of the errors, the automatic operation management module is executed, and a related statistical result is returned to the human-machine interface module and the database module, and the cyclic prediction operation is restarted.

11. The computer-readable medium of claim 2, wherein in the basic information storage module comprises;
the geographic location information includes a longitude, a latitude, an altitude, and how much the system is obscured by shadow;
the historical meteorological information includes solar radiance and ambient temperature information obtained hourly/monthly/daily from websites of weather stations, the NASA and the NOAA;
the installation information includes data plate information of photovoltaic modules, electric connection information of the photovoltaic modules, number of arrays, installation angles and mounting manners; and
the inverter information includes rated powers, efficiencies and maximum power tracking ranges.

12. The computer-readable medium of claim 8, wherein the automatic operation management module comprises:
a daily operation logging sub-module, configured to run automatically at 00:00 every day and perform statistical analysis on operation situation of the previous day, including statistics of basic information of prediction, system operation situations and operation results; and
a monthly operation logging sub-module, configured to run automatically at the first day of every month and perform statistical analysis on operation situation of the previous month, including statistics of basic information, system operation situations and operation results.

13. The computer-readable medium of claim 12, further comprising a cyclic prediction control module, configured to control the system to enter a cyclic prediction operation after storing of the basic information storage module is finished, wherein
an execution order of one single process of the cyclic prediction operation is as follows: the data input module, the data identification and correction module, the database module, the prediction model judgment module, the prediction data pre-processing module, the prediction modeling module, the prediction error analysis module, and the operation error diagnosis module;
after the execution of the single process of the cyclic prediction operation, a time judgment is performed; if it is not at 00:00, the prediction result is returned to the human-machine interface module and the database module, and the cyclic prediction operation is restarted; or if it is at 00:00, the prediction error analysis module is executed to perform statistics of the errors, the automatic operation management module is executed, and a related statistical result is returned to the human-machine interface module and the database module, and the cyclic prediction operation is restarted.
